(19) United States
(12) Patent Application Publication
(10) Pub. No.: US 2009/0215615 A1
(43) Pub. Date: Aug. 27, 2009

(54) METHOD OF FORMING SUPPORTED NANOPARTICLE CATALYSTS

(75) Inventors: Guoping Mao, Woodbury, MN (US); Gregory M. Haugen, Edina, MN (US); Jacqueline M. Aguilera, Chisago City, MN (US); Shane S. Mao, Pittsford, NY (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/456,724

(22) Filed: Jul. 11, 2006

(51) Int. Cl. B01J 23/42; B01J 23/745

(52) U.S. Cl. 502/326; 977/773

(57) ABSTRACT

A method of forming a supported catalyst, the method comprising forming a colloidal suspension of platinum-iron catalyst nanoparticles in a solvent, depositing at least a portion of the catalyst nanoparticles onto support particles, and removing at least a portion of the iron from the deposited catalyst nanoparticles.

### FIELD OF THE INVENTION

The present invention relates to catalysts for use in electrochemical devices, such as fuel cells. In particular, the present invention relates to methods of forming supported nanoparticle catalysts having good catalytic properties.

### BACKGROUND OF THE INVENTION

Fuel cells are electrochemical devices that produce usable electricity by the catalyzed combination of a fuel such as hydrogen and an oxidant such as oxygen. In contrast to conventional power plants, such as internal combustion generators, fuel cells do not utilize combustion. As such, fuel cells produce little hazardous effluent. Fuel cells convert hydrogen fuel and oxygen directly into electricity, and can be operated at higher efficiencies compared to internal combustion generators.

A fuel cell such as a proton exchange membrane (PEM) fuel cell typically contains a membrane electrode assembly (MEA), formed by an electrolyte membrane disposed between a pair of catalyst layers, which are correspondingly disposed between a pair of gas diffusion layers. The respective sides of the electrolyte membrane are referred to as an anode portion and a cathode portion. In a typical PEM fuel cell, hydrogen fuel is introduced into the anode portion, where the hydrogen reacts and separates into protons and electrons. The electrolyte membrane transports the protons to the cathode portion, while allowing a current of electrons to flow through an external circuit to the cathode portion to provide power. Oxygen is introduced into the cathode portion and reacts with the protons and electrons to form water and heat.

A common obstacle in the commercial application of PEM fuel cells is the performance of the catalyst layers. Catalyst layers typically include catalyst particles (e.g., platinum particles) and have catalytic properties that are dependent on the surface areas of the catalyst particles. As such, to achieve desirable operation voltages in fuel cells, there is an ongoing need for catalyst particles that have high surface areas, and for methods of forming such catalyst particles.

### BRIEF SUMMARY OF THE INVENTION

The present invention relates to a method of forming a supported catalyst that has good catalytic properties. The method includes forming a colloidal suspension of platinum-iron catalyst nanoparticles, depositing at least a portion of the catalyst nanoparticles onto support particles, and removing at least a portion of the iron from the deposited catalyst nanoparticles.

### BRIEF DESCRIPTION OF THE DRAWINGS

FIG. 1 is a flow diagram of a method for forming a supported catalyst.

FIG. 2 is a flow diagram of a method for forming a fuel cell containing a supported catalyst.

FIG. 3 is a graph representing potentiodynamic polarization curves for MEAs containing supported catalysts and a comparative MEA.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

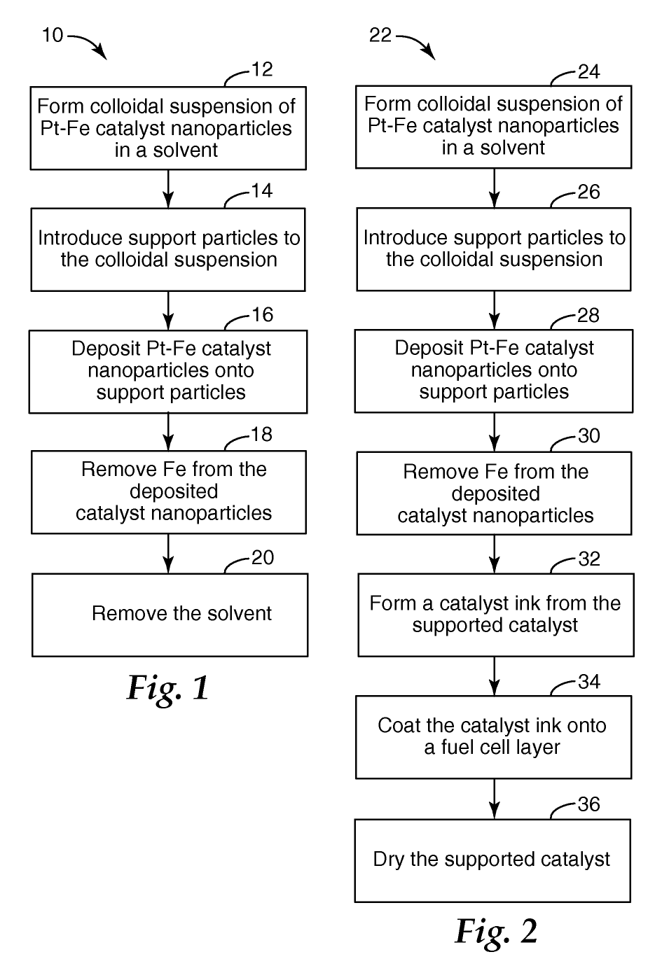

FIG. 1 is a flow diagram of method 10 for forming a supported catalyst that may be used in a variety of industrial catalytic processes. Method 10 includes steps 12-20, and initially involves forming a colloidal suspension of unprotected catalyst nanoparticles in a solvent, where the catalyst nanoparticles include platinum (Pt) and iron (Fe) (step 12). The colloidal suspension is formed by initially mixing a platinum-containing halogen and an iron-containing halogen in the solvent. The pH of the resulting mixture is then increased by introducing a basic compound (e.g., sodium hydroxide) into the mixture at a controlled rate. Examples of suitable pH levels for forming the colloidal suspension include pHs of at least about 5, with particularly suitable pHs including at least about 7, and with even more particularly suitable pHs including at least about 10. The increased pH causes the platinum and iron to disassociate from the halogens, allowing platinum and iron particles to associate together to form the catalyst nanoparticles. As the pH increases, the mixture becomes an opaque white color until a pH of about 11-12 is reached. At this point, the mixture becomes a transparent, yellow color.

After the pH is increased, the mixture is then heated to disperse the catalyst nanoparticles in the solvent without the use of protecting agents (e.g., surfactants, polymers, and organic ligands). Examples of suitable heating temperatures include temperatures of at least about 150° C., with particularly suitable temperatures including at least about 190° C. After heating, the resulting colloidal suspension becomes a transparent, dark brown color, which shows that the catalyst nanoparticles are homogenously dispersed in the solvent.

Support particles are then introduced and mixed into the colloidal suspension (step 14). The support particles may be pre-sheared to increase surface areas and break up agglomerates. After the support particles are mixed in the colloidal suspension, at least a portion of the catalyst nanoparticles are then deposited onto the support particles (step 16). This is performed by altering the stability of the catalyst nanoparticles in the solvent. In one embodiment, the stability is altered by reducing the pH of the colloidal suspension at a controlled rate, which causes a portion of the catalyst nanoparticles to condense and bond to the outer surfaces of the support particles. The pH of the colloidal suspension may be reduced by introducing an acidic compound (e.g., nitric acid) into the colloidal suspension at a controlled rate. Examples of suitable pH levels for depositing the catalyst nanoparticles onto the support particles include pHs of less than about 5.

At least a portion of the iron is then removed from the deposited catalyst nanoparticles (step 18). The iron removal is performed by altering the solubility of the iron in the solvent, which leaches the iron from the deposited catalyst nanoparticles. In one embodiment, the solubility of the iron is altered by lowering of the pH of the colloidal suspension. As a result, when the pH of the colloidal suspension is lowered for depositing the catalyst nanoparticles onto the support particles, the lowered pH also leaches iron from the catalyst nanoparticles in a substantially simultaneous manner. After the catalyst nanoparticles are deposited onto the support particles, the iron continues to leach from the catalyst nanoparticles, rendering the resulting catalyst nanoparticles at least partially porous. This increases the exposed surface areas of the platinum portions of the catalyst nanoparticles, particularly at the interfacial boundaries between the catalyst nanoparticles and the support particles. The increased exposed surface areas of the platinum portions correspondingly increases the catalytic properties of the resulting supported catalysts.

In an alternative embodiment, the solubility of the iron is altered by applying an electrical potential to the solvent of the colloidal suspension after the catalyst nanoparticles are deposited onto the support particles. The electrical potential also causes at least a portion of the iron to leach from the catalyst nanoparticles, thereby increasing the exposed surface areas of the platinum portions of the catalyst nanoparticles. Furthermore, an electrical potential may be applied to the solvent of the colloidal suspension in combination with the reducing the pH of the colloidal suspension to leach the iron from the catalyst nanoparticles.

The amount of iron removed from the catalyst nanoparticles generally depends on the initial iron concentration and on the duration of the exposure to the solubility-altering conditions. Examples of suitable amounts of iron removed from the catalyst nanoparticles include at least about 50% of the initial iron concentration in the catalyst nanoparticles, with particularly suitable amounts of iron removed including at least about 75% of the initial iron concentration. In one embodiment, some iron remains in the catalyst nanoparticles during the formation process of method 10, which allows the remaining iron to function as a catalyst promoter.

After removing the iron, the solvent is removed in a drying process (step 20), thereby providing the supported catalyst. The resulting supported catalyst includes catalyst nanoparticles having small average particle sizes with low standard deviations in particle sizes. Examples of suitable average particle sizes of the catalyst nanoparticles in the supported catalyst, after the iron removal, includes particle sizes of about 2.0 nanometers or less, with suitable standard deviations of about 0.5 nanometers or less. The supported catalyst formed pursuant to method 10 is suitable for use in a variety of industrial catalytic processes, such as hydrogenation, hydrosilylation, and petroleum refining. Furthermore, the supported catalyst is particularly suitable for use in catalyst layers of electrochemical devices, such as PEM fuel cells. The increased surface area of the catalyst nanoparticles correspondingly increases the catalytic properties of the supported catalyst, thereby increasing the attainable operation voltages.

FIG. 2 is a flow diagram of method 22 for forming a fuel cell containing the supported catalyst. Method 22 includes steps 24-36, where steps 24-30 are the same as steps 12-18 of method 10 (shown in FIG. 1 and discussed above). After at least a portion of the iron is removed from the catalyst nanoparticles (step 30), the resulting supported catalyst is then used to form a catalyst ink (step 32). The catalyst ink is formed by combining the supported catalyst with a carrier fluid (e.g., water) and a polymer solution, such as 10% sulfonated tetrafluorethylene copolymer solution commercially available under the trade designation “NAFION 1100” from DuPont Chemicals, Wilmington, Del. The combined components are mixed and heated to boiling, and then cooled to room temperature.

The catalyst ink is then coated onto a layer of a fuel cell or other electrochemical device (step 34). In one embodiment, the fuel cell layer is a gas diffusion layer. In an alternative embodiment, the fuel cell layer is a polymer electrolyte membrane. In either embodiment, the supported catalyst may be coated to function as an anode catalyst layer, a cathode catalyst layer, or a combination of anode and cathode catalyst layers. The supported catalyst may be coated on a fuel cell layer in a variety of manners, such as by extrusion coating, knife coating, notch coating, and hand coating.

In one embodiment, the fuel cell layer is a gas diffusion layer (e.g., carbon paper) that is treated for hydrophobic properties, and is pre-coated with a conductive material (e.g., carbon black) to increase the bond between the gas diffusion layer and the catalyst ink. In this embodiment, the catalyst ink is coated on the layer of conductive material to function as a catalyst layer for the fuel cell.

Once the catalyst ink is coated on the fuel cell layer, the catalyst ink and the fuel cell layer are dried (step 36). The resulting catalyst-coated layer is then assembled with additional layers to form the fuel cell. For example, in the embodiment in which the catalyst ink is coated on a gas diffusion layer, the coated gas diffusion layer is then secured to a PEM such that coating of catalyst ink is disposed between the gas diffusion layer and the polymer electrolyte membrane. During operation, the supported catalyst of the catalyst ink provides a first catalytic site where hydrogen or reformate gases react and separate into protons and electrons (i.e., an anode catalyst layer) and/or provides a second catalytic site where oxygen reacts with the electrons and protons to form water and heat (i.e., a cathode catalyst layer). The small particle sizes and increased exposed surface areas of the platinum nanoparticles increases the catalytic properties of the supported catalyst, thereby increasing the attainable operation voltages of the fuel cell.

As discussed above, the colloidal suspension is formed in steps 12 and 24 of methods 10 and 22 by initially mixing a platinum-containing halogen and an iron-containing halogen in the solvent. Examples of suitable platinum-containing halogens include platinum-based chlorides, such as dihydrogen hexachloroplatinate (H₂PtCl₆), platinum chlorides (e.g., PtCl₂ and Pt₆Cl₁₂), hydrated compounds thereof, and combinations thereof. Examples of suitable iron-containing halogens include iron-based chlorides, such as iron trichloride (FeCl₃) and hydrated compounds thereof. Examples of suitable molar concentrations of platinum in the catalyst nanoparticles of the colloidal suspension include at least about 50% platinum, with particularly suitable molar concentrations ranging from about 50% to about 75%, where the residual concentrations constitute iron.

Examples of suitable solvents of the colloidal suspension include polyalcohols, such as alkylene glycols, with particularly suitable alkylene glycols including ethylene glycol, propylene glycol, and combinations thereof. The solvent may also include water and low-molecular weight alcohols (e.g., isopropanol), where the polyalcohol desirably constitutes at least about 75 weight percent of the solvent, and more desirably constitutes at least about 90 weight percent of the solvent.

Examples of suitable support particles include porous materials, such as carbon particles (e.g., carbon black), silica particles, zirconia particles, metal oxide particles, and combinations thereof. Examples of suitable carbon support particles include those commercially available under the trade designations “SHAW C-55” from Chevron Texaco Corp., Houston, Tex.; and “VULCAN XC-72” and “BLACK PEARL 2000”, both from Cabot Corp., Waltham, Mass.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

### Example 1

An MEA of Example 1, which included a supported catalyst of the present invention as an anode catalyst layer, was prepared pursuant to the following procedure:

1. Preparation of the Supported Catalyst

The supported catalyst was prepared by initially combining 0.58 grams (2.2 millimole) of iron chloride hexahydrate (FeCl₃*6H₂O), 1.0 gram (2.2 millimole) of dihydrogen hexachloroplatinate solution (H₂PtCl₆*xH₂O), and 200 grams of ethylene glycol. The combined components were then mixed for 15 minutes in a 250-milliliter flask to form a glycol mixture that contained an initial platinum to iron (Pt—Fe) molar ratio of 1:1.

After the 15-minute mixing period, 48.0 grams of a sodium hydroxide solution (2.5% by weight sodium hydroxide in ethylene glycol) was added in a drop-wise manner while the glycol mixture was continually stirred. This increased the pH of the glycol mixture, which became opaque-white in color when the pH reached 10-11, and then became transparent yellow in color when the pH reached 11-12. The resulting mixture was then stirred for two hours at room temperature, and was subsequently heated in an oil bath at 190° C. for 3-5 hours with nitrogen purging. The resulting colloidal suspension exhibited a transparent, dark brown color.

A small jar was filled with 0.95 grams of carbon black support particles (trade designated “VULCAN XC-72” carbon black from Cabot Corp., Waltham, Mass.) and 25 grams of ethylene glycol. The support particle mixture was then sheared for two minutes at 30,000 rpm with a mechanical homogenizer (trade designated “HANDISHEAR” homogenizer from VirTis Company, Gardiner, N.Y.). The sheared support particle mixture was then transferred into another jar containing 242.0 grams of the colloidal suspension. The combined colloidal suspension was then sheared with the mechanical homogenizer for an additional 20 seconds.

After the shearing, 5 milliliters (1.86 moles) of nitric acid (HNO₃) was incrementally added to the combined colloidal suspension while stirring to reduce the pH of the combined mixture to 4-5. The combined colloidal suspension was then stirred overnight. This caused the catalyst nanoparticles of the colloidal suspension to deposit on the support particles, and also altered the stability of the iron, causing iron to begin leaching from the catalyst nanoparticles. After the stirring period, 10 milliliters of the nitric acid was then incrementally added while stirring, and the combined colloidal suspension was then stirred for another hour. This further altered the stability of the iron, causing additional portions of the iron to leach from the deposited catalyst nanoparticles.

After the one-hour period, 200 milliliters of deionized water was added to the combined colloidal suspension, and the combined colloidal suspension was filtered and washed with copious amounts of deionized water. The resulting wet catalyst cake was then dried overnight at 110° C. under a vacuum. The composition of the resulting supported catalyst was estimated to include about 30% by weight platinum based on the amount of iron chloride hexahydrate, dihydrogen hexachloroplatinate solution, and carbon black added.

2. Preparation of the Catalyst Ink

The supported catalyst was then used to prepare a catalyst ink pursuant to the following procedure. A mixture was prepared by combining 1.0 gram of the supported catalyst, 4.0 grams of water, and 4.0 grams of a 10% PFSA solution (10% perfluorosulfonic acid/polytetrafluoroethylene (PTFE) copolymer in the acid form solution commercially available under the trade designation “NAFION 1100” from DuPont Chemicals, Wilmington, Del.), and mixing the components in a jar. The mixture was then sheared at 30,000 rpm for 5 minutes with the mechanical homogenizer. The mixture was then heated to 100° F. for 30 minutes, and then cooled.

3. Preparation of the Catalyst-Coated Gas Diffusion Layer

After preparation, the catalyst ink was used to form a catalyst-coated gas diffusion layer of the MEA of Example 1 pursuant to the following procedure. A gas diffusion layer was initially prepared by dipping a 50-cm² piece of carbon paper (275-micrometer thick carbon paper commercially available under the trade designation “TORAY 2903” from Toray Industries, Inc., Tokyo, Japan) in a 5% PTFE dispersion (diluted 60% polytetrafluoroethylene aqueous dispersion commercially available under the trade designation “TEFLON”, Cat. No. T-30, from DuPont Chemicals, Wilmington Del.), and then drying the dipped carbon paper in an air oven at 50° C.-60° C. to drive off the water.

The gas diffusion layer was then pre-coated with a carbon black dispersion pursuant to the following procedure. An aqueous dispersion of carbon black particles (trade designated “VULCAN XC-72” carbon black from Cabot Corp., Waltham, Mass.) was prepared under high-shear stirring using a Roth mixer equipped with a 7.6-centimeter blade at 4,500 rpm. In a separate container, an additional batch of the 5% PTFE dispersion was prepared, and the carbon black dispersion was then added to the 5% PTFE dispersion with stirring.

The resulting mixture was filtered under vacuum to obtain a retentate that was approximately 20% solids mixture of water, PTFE, and carbon black. The pasty mixture was then treated with approximately 3.5% by weight of a surfactant (trade designated “TRITON X-100” from Union Carbide Corp., Danbury, Conn.), followed by the addition of isopropyl alcohol such that the weight proportion of isopropyl alcohol to the pasty mixture was 1.2:1. The diluted mixture was again stirred at high shear using a three-bladed VersaMixer having an anchor blade at 80 rpm, a dispersator at 7000 rpm, and a rotor-stator emulsifier at 5000 rpm, for 50 minutes at 10° C.

The resulting dispersion thus was then coated onto the dried gas diffusion layer at a wet thickness of approximately 0.050 millimeters using a notch bar coater. The dispersion was then dried overnight at 23° C. to remove the isopropyl alcohol, and then dried in an oven at 380° C. for 10 minutes. This produced a pre-coated gas diffusion layer having a thickness of about 0.025 millimeters and a basis weight (carbon black plus PTFE) of about 25 grams/meter². The pre-coated gas diffusion layer was then hand-coated (i.e., brushed) with the catalyst ink containing the supported catalyst in an amount yielding 0.4 milligrams of platinum per square centimeter (plus any iron remaining in the catalyst nanoparticles) after drying. The coated gas diffusion layer was then dried in a vacuum oven at 110° C. for 30 minutes to form the catalyst-coated gas diffusion layer.

4. Preparation of the PEM and the MEA

A PEM of the MEA of Example 1 was prepared by notch-coating an aqueous dispersion of the above-discussed 10% PFSA solution onto a backing of polyvinylchloride-primed polyethylene terephthalate (3M Corporation, St. Paul, Minn.) at a loading such that the final, dried film was approximately 25 micrometers thick. The cast film was first passed through a drying oven at 50° C.-60° C. (with a residence time of 3-4 minutes), and then dried at 130° C. for 4 minutes in an air-impingement oven to remove the remainder of the solvent and to anneal the PFSA film. The dried film was then peeled from the backing for subsequent use.

The PEM was then sandwiched between the above-formed catalyst-coated gas diffusion layer (cathode portion) and a second catalyst-coated gas diffusion layer (anode portion), where the second catalyst-coated gas diffusion layer contained a standard platinum-ruthenium/carbon black catalyst. The gas diffusion layers were oriented such that the catalyst coatings faced the PEM. A gasket of TEFLON-coated glass fiber was also placed on each side. The catalyst-coated gas diffusion layers were smaller in surface area than the PEM, and each fit in the window of the respective gasket. The thickness height of the gasket was 70% of the height of the catalyst-coated gas diffusion layers, to allow a 30% compression of the catalyst-coated gas diffusion layers when the entire MEA assembly was pressed. The MEA assembly was pressed in a Carver Press (Fred Carver Co., Wabash, Ind.) for 10 minutes at a pressure of 2.8 megapascals (i.e., 0.20 tons/inch²) and at a temperature of 130° C. The polyimide sheets were then peeled away leaving the finished five-layer MEA of Example 1 containing the supported catalyst as an anode catalyst layer.

### Example 2

An MEA of Example 2 was prepared pursuant to the procedure discussed above for Example 1, except that the supported catalyst was prepared by initially combining 0.36 grams (1.3 millimole) of iron chloride hexahydrate, 1.0 gram (2.2 millimole) of dihydrogen hexachloroplatinate solution, and 200 grams of ethylene glycol. The combined components were then mixed for 15 minutes in a 250-milliliter flask to form a glycol mixture that contained an initial platinum to iron (Pt—Fe) molar ratio of about 2:1.

### Example 3

An MEA of Example 3 was prepared pursuant to the procedure discussed above for Example 2, except that the pre-coated gas diffusion layer was hand-coated (i.e., brushed) with the catalyst ink containing the supported catalyst in an amount yielding 0.24 milligrams of platinum per square centimeter (plus any iron remaining in the catalyst nanoparticles). As such, the anode catalyst layer of the MEA of Example 3 contained a lower amount of the supported catalyst compared to the anode catalyst layer of the MEA of Example 2.

### Comparative Example A

An MEA of Comparative Example A was prepared pursuant to the following procedure, which was similar to the procedure for Example 2, except that the iron was not removed from the catalyst nanoparticles of the supported catalyst. The supported catalyst was prepared by initially combining by initially combining 0.36 grams (1.3 millimole) of iron chloride hexahydrate, 1.0 gram (2.2 millimole) of dihydrogen hexachloroplatinate solution, and 200 grams of ethylene glycol. The combined components were then mixed for 15 minutes in a 250-milliliter flask to form a glycol mixture that contained an initial platinum to iron (Pt—Fe) molar ratio of about 2:1.

After the 15-minute mixing period, 48.0 grams of a sodium hydroxide solution (2.5 weight percent sodium hydroxide in ethylene glycol) was added in a drop-wise manner while the glycol mixture was continually stirred. This increased the pH of the glycol mixture, which became opaque-white in color when the pH reached 10-11, and then became transparent yellow in color when the pH reached 11-12. The resulting mixture was then stirred for two hours at room temperature, and then was heated in an oil bath at 190° C. for 3-5 hours with nitrogen purging. The resulting colloidal suspension exhibited a transparent, dark brown color that was free of precipitates.

A small jar was then filled with 0.95 grams of carbon black support particles (trade designated “VULCAN XC-72” carbon black from Cabot Corp., Waltham, Mass.) and 25 grams of ethylene glycol. The support particle mixture was then sheared for two minutes at 30,000 rpm with a mechanical homogenizer (trade designated “HANDISHEAR” homogenizer from VirTis Company, Gardiner, N.Y.). The sheared support particle mixture was then transferred into another jar containing 242.0 grams of the colloidal suspension. The combined colloidal suspension was then sheared with the mechanical homogenizer for an additional 20 seconds.

After the shearing, the combined colloidal suspension was then stirred overnight, allowing the catalyst nanoparticles of the colloidal suspension to deposit on the support particles. However, because the stability of the iron was not altered, the iron did not leach from the catalyst nanoparticles. After the stirring, 200 milliliters of deionized water was then added to the combined colloidal suspension, and the combined colloidal suspension was filtered and washed with copious amounts of deionized water. The resulting wet catalyst cake was then dried overnight at 110° C. under a vacuum. The composition of the resulting supported catalyst was estimated to include about 30 weight percent platinum based on the amount of iron chloride hexahydrate, dihydrogen hexachloroplatinate solution, and carbon black added.

The remaining steps for preparing the catalyst ink, the gas diffusion layer, the PEM, and the MEA of Comparative Example A were then performed pursuant to the procedure discussed above for Example 1.

### MEA Performance Measurements

The MEAs of Examples 1-3 and Comparative Examples A were each quantitatively measured for potentiodynamic performance pursuant to the following procedure. The given MEA was mounted in a test cell station (Fuel Cell Technologies, Inc., Albuquerque, N. Mex.), which included a variable electronic load with separate anode and cathode gas handling systems to control gas flow, pressure, and humidity. The electronic load and gas flow were computer controlled.

Fuel cell polarization curves were obtained under the following test parameters: an electrode of area 50 square centimeters, a cell temperature of 70° C., and anode gas pressure (gauge) of 0 psig, and anode hydrogen flow rate, 800 standard cubic centimeters/minute, an anode humidification temperature of 70° C., a cathode gas pressure (gauge) of 0 psig, a cathode air flow rate of 1,800 standard cubic centimeters/minute, and a cathode humidification temperature of 70° C. The cathode gas was a reformate fuel containing 45% hydrogen, 33% nitrogen, 22% CO₂, and 50 parts-per-million CO, with a 2% of total flow air bleed. Humidification of the anode and the cathode gas streams was provided by passing the gas through sparge bottles maintained at the stated temperatures. The fuel cell was brought to operating conditions at 70° C. under gas and air flows. Test protocols were initiated after 12 hours of operation, at which time the test parameters were measured. Table 1 provides the potentiodynamic polarization scans for the MEAs of Examples 1-3 and Comparative Example A.

TABLE 1

| | Pt—Fe Initial | Pt Loading | Performance at 0.2 | Performance at 0.6 |
|---|---|---|---|---|
| Example | Molar Ratio | (mg/cm²) | A/cm² (mV) | A/cm² (mV) |
| Example 1 | 1:1 | 0.40 | 730 | 612 |
| Example 2 | 2:1 | 0.40 | 751 | 652 |
| Example 3 | 2:1 | 0.24 | 717 | 576 |
| Comparative Example A | 2:1 | 0.40 | 732 | 621 |

The data in table 1 show the superior catalytic properties of the supported catalysts formed pursuant to the method the present invention. A comparison of the results between Example 2 and Comparative Example A show that the removal of the iron from the catalyst nanoparticles of Example 2 increases the catalytic properties of the supported catalyst used in the MEA of Example 2. As discussed above, this is believed to be due to the increased surface area of the platinum in the deposited catalyst nanoparticles. Furthermore, the results of Examples 1 and 3 show that lower Pt—Fe ratios (1:1) and lower catalyst loadings (0.24 mg/cm²) also provide good catalytic properties.

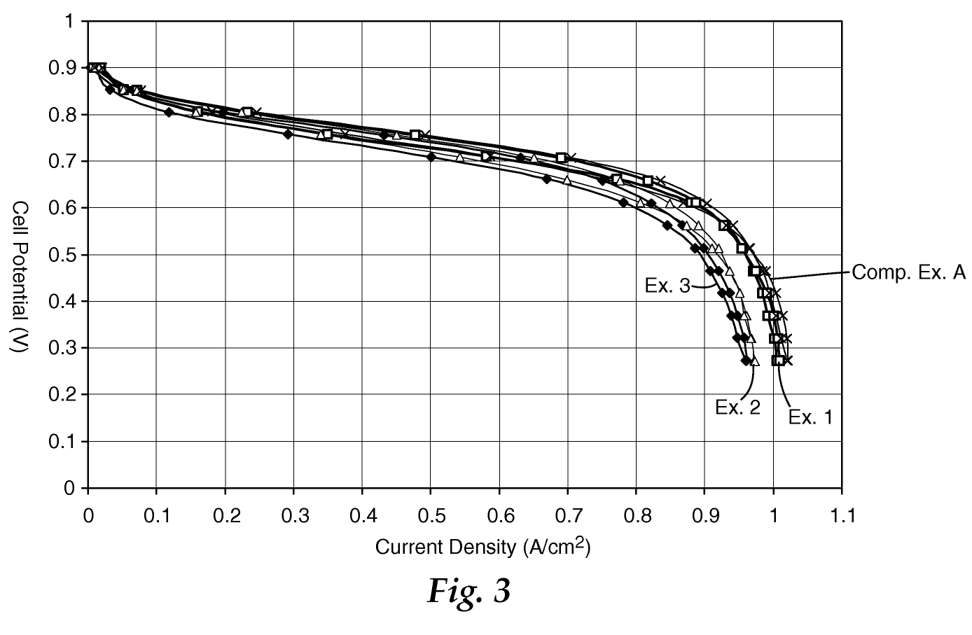

FIG. 3 is a graph representing potentiodynamic polarization curves for the MEAs of Examples 1-3 and Comparative Example A, in which hydrogen was used in place of the reformate gas. While the distinctions between the results of Example 2 and Comparative Example A are greater with the use of reformate gas, the data shown in FIG. 3 also illustrate the good catalytic properties of the supported catalysts of the present invention.

Although the present invention has been described with reference to preferred embodiments, workers skilled in the art will recognize that changes may be made in form and detail without departing from the spirit and scope of the invention.

1.-8. (canceled)

9. A method of forming a supported catalyst, the method comprising:
forming a colloidal suspension of catalyst nanoparticles in a solvent having a pH of at least about 5, wherein the catalyst nanoparticles comprise platinum and iron;
introducing support particles to the colloidal suspension;
depositing at least a portion of the catalyst nanoparticles onto the support particles; and
lowering the pH of the solvent to remove at least a portion of the iron from the deposited catalyst nanoparticles;
wherein depositing the portion of the catalyst nanoparticles and lowering the pH of the solvent are performed substantially simultaneously.

10. (canceled)

11. The method of claim 9, further comprising applying an electrical potential to the solvent.

12. The method of claim 9, further comprising removing the solvent from the deposited catalyst nanoparticles.

13. The method of claim 9, wherein the platinum constitutes at least about 50 molar percent of the catalyst nanoparticles in the colloidal suspension.

14. The method of claim 9, wherein forming the colloidal suspension comprises mixing a platinum-containing halogen and an iron-containing halogen in the solvent.

15. The method according to claim 9, additionally comprising:
coating the supported catalyst onto a layer of a fuel cell; and
drying the supported catalyst.

16. (canceled)

17. The method of claim 15, wherein at least a portion of the deposited catalyst nanoparticles are porous after the iron removal.

18. The method of claim 15, wherein the layer of the fuel cell is selected from the group consisting of a gas diffusion layer and a polymer electrolyte membrane.

19. The method of claim 15, wherein the catalyst nanoparticles have an average particle size of about 2 nanometers or less after the iron removal.

20. The method of claim 19, wherein the catalyst nanoparticles have a standard deviation of particle sizes of about 0.5 nanometers or less after the iron removal.
